(19) United States
(12) Patent Application Publication
(10) Pub. No.: US 2022/0156733 A1
(43) Pub. Date: May 19, 2022

(54) BLOCKCHAIN SYSTEM, APPROVAL TERMINAL, USER TERMINAL, HISTORY MANAGEMENT METHOD, AND HISTORY MANAGEMENT PROGRAM

(71) Applicant: Nippon Telegraph and Telephone Corporation, Tokyo (JP)

(72) Inventors: Hiroki WATANABE, Musashino-shi, Tokyo (JP); Tatsuro ISHIDA, Musashino-shi, Tokyo (JP); Shigenori OHASHI, Musashino-shi, Tokyo (JP); Shigeru FUJIMURA, Musashino-shi, Tokyo (JP); Atsushi NAKADAIRA, Musashino-shi, Tokyo (JP)

(21) Appl. No.: 17/600,874

(22) PCT Filed: Mar. 19, 2020
(86) PCT No.: PCT/JP2020/012289

§ 371 Date: Oct. 1, 2021

(30) Foreign Application Priority Data
Apr. 2, 2019 (JP) 2019-070600

(51) Int. Cl. G06Q 20/38; G06Q 20/06

(52) U.S. Cl. CPC G06Q 20/3825; G06Q 20/065; G06Q 20/3827; G06Q 20/38215

(57) ABSTRACT

A history of data can be tracked easily on a blockchain. In a blockchain system, a distributed ledger 11 includes a state database that stores a state of a smart contract for each token. A user terminal 1 includes a transaction issue unit 13 that issues a transaction that updates a token. An approval terminal 2 includes an update unit 154 that updates the token in the state database, and a block generation unit 153 that generates the block including the transaction and causes the block and the updated state database to be reflected in the distributed ledger 11. The update unit 154 sets tracking data in the token in the state database, the tracking data including an update block number and token information on the token.

### TECHNICAL FIELD

The present invention relates to a technology that manages a history of a smart contract blockchain.

### BACKGROUND ART

A mechanism for securing the reliability without the need for centralized management is becoming widespread, centered on the digital cryptocurrency Bitcoin. With this mechanism, called a blockchain, the reliability of exchanged information is ensured by a consensus-forming process in a distributed network, while in addition, soundness is ensured by preventing frauds such as falsifications and double spending in the entire system.

In a blockchain, the pieces of information (transactions) communicated among participants are collected into a unit called a “block”, and each block is chained together and managed in time-series order. New blocks are approved by a consensus algorithm on the distributed network such as proof of work. The approval of a new block indicates that the transaction recorded in the block has gained the consensus of the entire system.

A record of the series of transaction information managed using the blockchain is called a “distributed ledger”, and each terminal participating in the network holds the same distributed ledger. In recent years, a blockchain platform technology has also been developed in which advanced script code is registered in the distributed ledger and consensus is reached regarding the execution of the script code and the result. For example, a blockchain platform called Ethereum has a distributed ledger that executes a script code by treating a transaction as input, stores the execution result in a key-value store (called a state DB) with a tree structure, and records a representative value of the store at that time in a block. The script code that is registered on the blockchain and also registered and executed by each terminal in this way is called a “smart contract”.

In a smart contract blockchain, each block and the state DB of the smart contract at the time of the block are managed in association with each other (see Non-Patent Literature 1).

Additionally, a technology is researched that uses one of blockchain platforms, namely Ethereum, to enhance the traceability of a supply chain using smart contracts (see Non-Patent Literature 2).

### CITATION LIST

### Non-Patent Literature

Non-Patent Literature 1: “JavaScript API⋅ethereum/wiki Wiki⋅GitHub”, https://github.com/ethereum/wiki/wiki/JavaScript-API#contract-methods

Non-Patent Literature 2: Kentaroh Toyoda, “A Novel Blockchain-Based Product Ownership Management System (POMS) for Anti-Counterfeits in the Post Supply Chain”, IEEE Access

### SUMMARY OF THE INVENTION

### Technical Problem

Due to the data structure of a blockchain, it is easy to specify a block number and reference a state at the time of that block. However, it is difficult to know how a value of the state at that block changed at which block in the past. This problem is particularly important from the standpoint of guaranteeing the traceability of information.

For example, when tracking a product in a supply chain, it is possible to reference the latest state at the time as indicated in Non-Patent Literature 2, but referencing a past state requires a brute-force search using the block number as the key.

In the case of performing advanced searching and tracking, such as tracking a change in a certain value of the state, a method is conceivable in which an external database such as an RDBMS is prepared, all pieces of data extracted from the blockchain are dropped into the external database, an index is constructed for the external database to search/track the desired data. However, constructing and maintaining a search system using an external database is costly for general users.

Additionally, in Non-Patent Literature 2, cases where the supply chain is more complex are not considered. For example, the case where materials are combined with each other to complete a different product (merging), the case where different content is generated from certain digital content (splitting), and the like are not considered. In such complex use cases, searching is more difficult even if an external database is used.

The present invention has been devised in light of the above described problems, and an object of the present invention is to provide a technology that enables tracking of a history of data easily on a blockchain.

### Means for Solving the Problem

To achieve the above object, one aspect of the present invention is a blockchain system provided with a user terminal and an approval terminal. A distributed ledger of the blockchain system includes a state database that stores a state of a smart contract for each token. The user terminal includes a transaction issue unit that issues a transaction that updates a token. The approval terminal includes an update unit that updates the token in the state database, and a block generation unit that generates a block including the transaction, and causes the block and the updated state database to be reflected in the distributed ledger. The update unit sets tracking data in the token in the state database, the tracking data including an update block number of the block in which the token is updated and token information on the token.

Another aspect of the present invention is an approval terminal that approves a transaction in a blockchain system. The approval terminal includes a distributed ledger that includes a state database that stores a state of a smart contract for each token, a reception unit that receives a transaction that updates a token, an update unit that updates the token in the state database, and a block generation unit that generates a block including the transaction, and causes the block and the updated state database to be reflected in the distributed ledger. The update unit sets tracking data in the token in the state database, the tracking data including an update block number of a block in which the token is updated and token information about the token.

Still another aspect of the present invention is a user terminal in a blockchain system. The user terminal includes a distributed ledger that includes a state database that stores a state of a smart contract for each token, and a history search unit that acquires tracking data including an update block number of a block in which a token is updated from the state database, specifies a search block number computed from the update block number, and acquires a state and the tracking data of the token in a block at the time of the search block number from the state database. The tracking data includes the update block number and token information on the token.

Still further another aspect of the present invention is a history management method that manages a history of a blockchain. In the history management method, a distributed ledger of the blockchain includes a state database that stores a state of a smart contract for each token. The history management method includes issuing, by a user terminal, a transaction that updates a token, updating, by an approval terminal, the token in the state database, and generating, by the approval terminal, a block including the transaction, and causing the block and the updated state database to be reflected in the distributed ledger. In the step of updating, tracking data is set in the token in the state database, the tracking data including an update block number of a block in which the token is updated and token information about the token.

Another aspect of the present invention is a history management program for causing a computer to function as the approval terminal.

### Effects of the Invention

According to the present invention, a technology can be provided, which makes it possible to track a history of data easily on a blockchain.

### BRIEF DESCRIPTION OF DRAWINGS

FIG. 1 is a diagram illustrating an overall configuration of a blockchain system according to an embodiment of the present invention.

FIG. 2 is a configuration diagram illustrating a configuration of a block issue unit.

FIG. 3 is a diagram illustrating a configuration of a distributed ledger.

FIG. 4 is an example of a transition diagram illustrating token transitions.

FIG. 5 is a schematic diagram for explaining the setting of tracking data when the state is updated.

FIG. 6 is a schematic diagram for explaining the setting of tracking data when tokens are merged.

FIG. 7 is a diagram illustrating an example of a state table when tokens are merged.

FIG. 8 is a schematic diagram for explaining the setting of tracking data when a token is split.

FIG. 9 is a sequence diagram illustrating block generation and history search.

FIG. 10 is a diagram illustrating an example of a transaction.

### DESCRIPTION OF EMBODIMENTS

Hereinafter, embodiments of the present invention will be described with reference to the drawings.

### Configuration Blockchain System

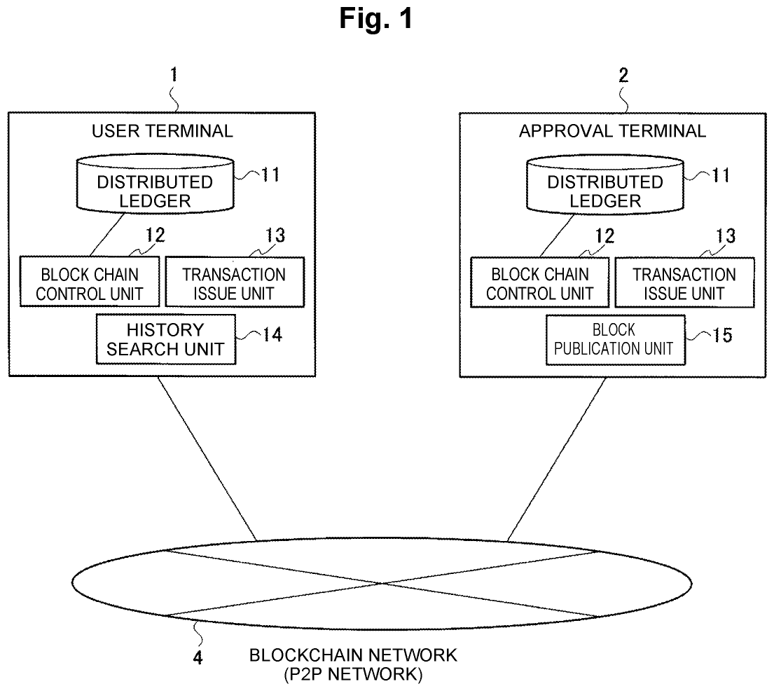

FIG. 1 is a diagram illustrating an overall configuration of a blockchain system according to the present embodiment. The blockchain according to the present embodiment is a smart contract blockchain that uses one of the blockchain platform technologies as Ethereum. Ethereum is an application development platform for using a blockchain as a distributed ledger for recording state transitions. However, the present invention is not limited to Ethereum, and a blockchain other than Ethereum may also be used.

The blockchain system illustrated in FIG. 1 is provided with a user terminal 1 and an approval terminal 2. These terminals 1 and 2 are connected to a P2P blockchain network 4 (hereinafter referred to as the “network”) in an autonomous and decentralized way. Note that a plurality of terminals besides the terminals 1 and 2 illustrated in the diagram are connected to the network 4. For example, a plurality of user terminals 1 and a plurality of approval terminals 2 may be connected. Each terminal connected to the network 4 is provided with a distributed ledger 11 described later, a blockchain control unit 12, and a transaction issue unit 13, with each terminal maintaining the system by mutually verifying the data recorded in the distributed ledger 11 and each other's transactions.

The user terminal 1 is a terminal (node) used by a user who uses the blockchain and smart contracts. The user terminal 1 is provided with the distributed ledger 11, the blockchain control unit 12, the transaction issue unit 13, and a history search unit 14.

The latest state of the blockchain is stored nearly in real time e in the distributed ledger 11 by loosely synchronizing with all terminals connected to the network 4 through the blockchain control unit 12. The blockchain and a dataset managed by the blockchain are stored in the distributed ledger 11 of the present embodiment.

The blockchain control unit 12 maintains the blockchain system by cooperating with other terminals connected to the network 4 in an autonomous and decentralized way. The blockchain control unit 12 accesses the distributed ledger 11 and reads out or updates the blockchain and the dataset in the distributed ledger 11.

The transaction issue unit 13 issues transactions to the network 4. In the present embodiment, the transaction issue unit 13 issues transactions that update a token. Specifically, the transaction issue unit 13 issues transactions that update the value of a state of a token, transactions that merge a plurality of tokens, transactions that split a token and the like.

The history search unit 14 acquires tracking data including an update block number of a block in which a token is updated from a state DB in its own distributed ledger 11, specifies a search block number computed from the update block number, and acquires, from the state DB, the state and tracking data of a token at the block at the time of the search block number. The history search unit 14 accesses the distributed ledger 11 through the blockchain control unit 12.

The approval terminal 2 is a terminal used by a verifier of transactions referred to as a miner for example. The approval terminal 2 collects transactions transmitted to the network 4, and after confirming the validity of a transactions, generates a block through approval work. The approval terminal 2 is provided with the distributed ledger 11, the blockchain control unit 12, the transaction issue unit 13, and a block issue unit 15. The distributed ledger 11, the blockchain control unit 12, and the transaction issue unit 13 of the approval terminal 2 are similar to the distributed ledger 11, the blockchain control unit 12, and the transaction issue unit 13 of the user terminal 1.

The block issue unit 15 verifies transactions issued on the network 4, and attempts to generate a block according to a consensus algorithm for generating a block, such as proof of work.

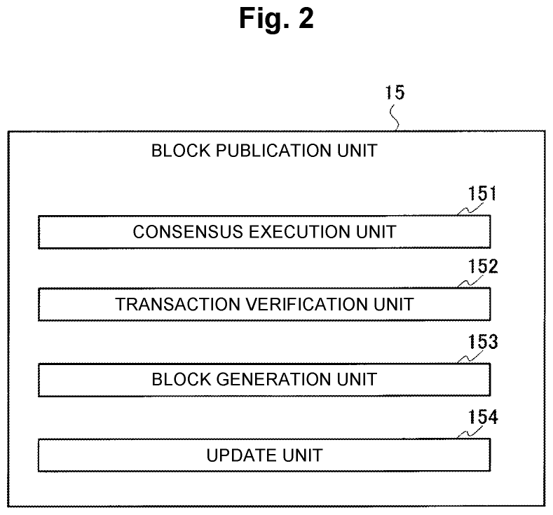

FIG. 2 is a configuration diagram illustrating a configuration of the block issue unit 15 provided in the approval terminal 2. The block issue unit 15 illustrated in the diagram is provided with a consensus execution unit 151, a transaction verification unit 152, a block generation unit 153, and an update unit 154.

The consensus execution unit 151 performs calculations necessary for reaching consensus, such as hash operations. Besides the proof of work used in Bitcoin, the consensus algorithm may use another type of consensus algorithm for block generation, such as proof of stake using the quantity of owned coins as a resource, or PBFT, which is a consensus algorithm for tolerating a Byzantine fault.

The transaction verification unit 152 receives a transaction from the network 4, and verifies the transaction such as the validity of an electronic signature of the received transaction.

The block generation unit 153 generates a single block combining the transactions issued on the network 4 within a predetermined length of time. In other words, in the case of successful verification by the transaction verification unit 152, the block generation unit 153 generates a block including the transaction, and causes the generated block to be reflected in the distributed ledger 11 of all terminals connected to the network 4.

The block generation unit 153 of the present embodiment generates a block including a transaction that updates a token, and causes the block and the state DB updated by the update unit 154 to be reflected in the distributed ledger 11. The block generation unit 153 also sets a hash value of the updated state DB in the block header of the block to be generated.

The update unit 154 updates the state DB, which is a part of the dataset in its own distributed ledger 11, on the basis of the transaction that updates a token. In the present embodiment, the update unit 154 sets, in a token of the state DB, tracking data including the update block number of the block whose token is updated and token information about the token. The token information of the present embodiment includes an ID of the token and an address of a smart contract of the token.

The update unit 154 also sets, to the merged token obtained by merging the plurality of tokens, as tracking data, the block number of a block generating a merged token as well as the token IDs and smart contract addresses of the plurality of the merging parent tokens. The update unit 154 also sets, to a split token obtained by splitting, as tracking data, the block number of a block generating the split token as well as the token ID and smart contract address of the splitting parent token.

Additionally, the update unit 154 sets a consumed flag which indicates that the plurality of merging parent tokens or the splitting parent tokens in the state DB have been consumed.

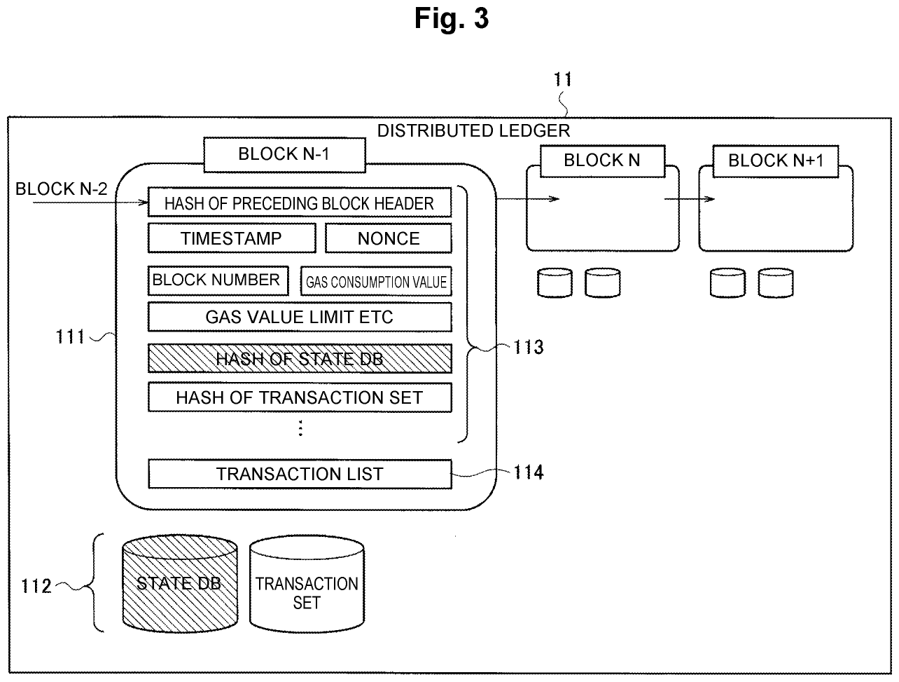

FIG. 3 illustrates a configuration of the distributed ledger 11 in each terminal. The distributed ledger 11 of the present embodiment is provided with a blockchain including a plurality of blocks 111 and a dataset 112 managed in correspondence with each block.

Each block 111 includes information such as a block header 113 and a transaction list 114. In the block header 113, a summary of the entire distributed ledger 11 at the time of the block is set. In the example illustrated in the diagram, a summary value of the dataset 112 (such as a hash value of the state DB or a hash value of a transaction set) is set in the block header 113 as a snapshot of the dataset 112 at a certain time. For example, in the case where the dataset is stored in a tree structure such as a Merkle tree, the root hash of the Merkle tree is set as a summary value. The transaction list 114 is a list of transactions included in the block 111.

The use and purpose of the dataset 112 are not limited. In the distributed ledger 11 illustrated in the diagram, a state DB and a transaction set DB are provided as the dataset 112.

The state DB is a DB for managing a state value or status of a smart contract at the time of a certain block. The bytecode of the smart contract is also stored in the state DB. In the present embodiment, information is recorded in the state DB in data units called tokens. Here, a token refers to a data structure expressed by a smart contract, and indicates the data managed on the blockchain. In other words, the state DB of the present embodiment stores the state of a smart contract for each token.

Also, the state DB of the present embodiment is set with tracking data including the update block number of a block in which a token is updated in each token by the update unit 154 of the approval terminal 2. The state DB functions as a key-value store (KVS) that receives identification information (for example, a token ID) uniquely specifying a token as input, and outputs the state value and the tracking data of the token.

Note that in Ethereum, if the bytecode of a smart contract is registered in the distributed ledger 11 (state DB), identification information indicating the smart contract is attached. Since a transaction can be transmitted to the identification information, the identification information of a smart contract is also referred to as the address of the smart contract. The difference from sending money to the address of a user resides in that when a transaction is transmitted to the address of a smart contract, the smart contract is executed.

The transaction set DB is a DB indicating the set of transactions at the time of a certain block. The set of transactions means a Merkle tree including all transactions at the time of a certain block.

### Token State Transitions

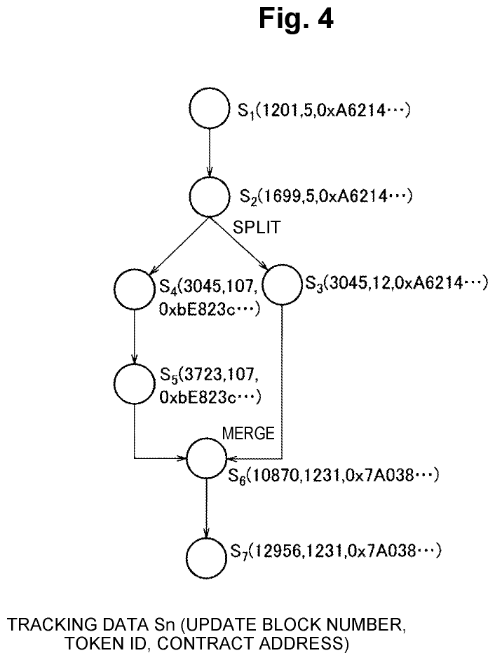

FIG. 4 is an example of a transition diagram illustrating token transitions in the present embodiment.

With the token of the present embodiment, it is not only possible to update the state, but also split and merge tokens. Token splitting refers to splitting a single token into multiple tokens. There are two types of token splitting as follows. The first type is the case where the splitting parent token is split to generate multiple new tokens, and the splitting parent token is consumed. The second type is the case where a portion of the splitting parent token is cut away to form a new token, and the splitting parent token continues to exist with only a portion thereof consumed. Token merging refers to merging a plurality of tokens into a single token.

Consequently, token transitions in the present embodiment can be expressed using a directed acyclic graph (DAG) as illustrated in the diagram. In graph theory, a DAG is a directed graph with no closed paths.

In the example illustrated in the diagram, the tracking data of each token is expressed by Si (update block number, token ID, contract address). The tracking data will be described later. The subscripts i=1 to N indicate tracking data for different unique states. For example, the token S2 indicates that the update block number is “1699”, the token ID is “5”, and the contract address is “0xA6214 . . . ”. Also, the token S4 is a token obtained by splitting the token S2. The token S6 is a token obtained by merging the token S5 and the token S3.

### Setting Tracking Data

Next, the process by which the approval terminal 2 sets tracking data for tracking a history of a token in the state DB when updating the token of the state DB will be described. In the embodiment, updating a token includes not only updating the state, but also merging and splitting with other tokens. Consequently, the tracking data of the present embodiment includes the update block number of the block at the update time when the token is updated, the token ID, and the address of the smart contract (hereinafter, referred to as the “contract address”).

With this arrangement, it is not only possible to track a history of the token with the same ID inside a single smart contract, but also associate a token having another ID with another related smart contract. As a result, a history of tokens among a plurality of smart contracts can be tracked.

Hereinafter, token updating will be described for the three cases of state updating, token merging, and token splitting.

### 1. State Updating

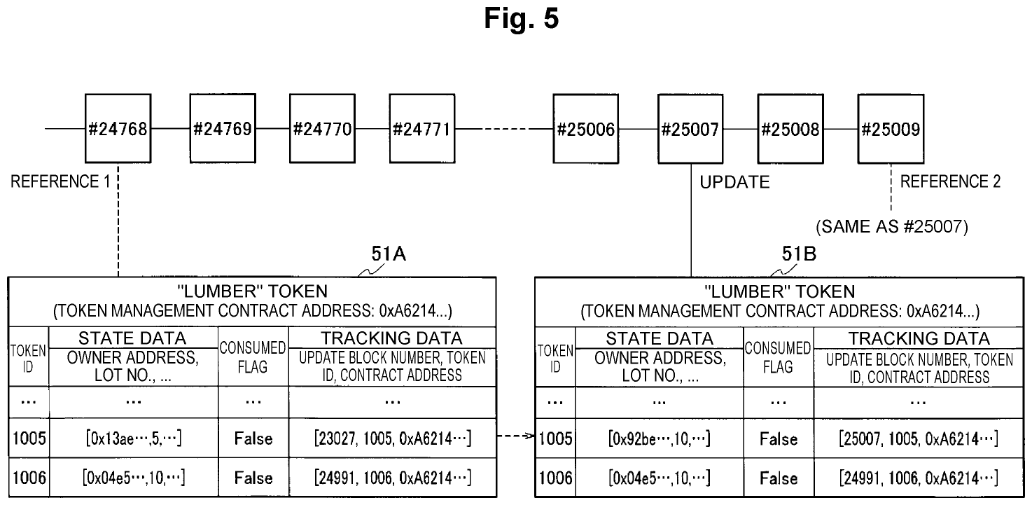

FIG. 5 is a schematic diagram for explaining a process of attaching tracking data to a token (or state) in the case of updating the state (status, variable) of the token. In the example illustrated in the diagram, the states of lumber tokens are updated as part of a process of manufacturing furniture from lumber.

As described above, blocks and the state DB are stored in association with each other in the distributed ledger 11. The state DB manages the states of tokens for each smart contract. FIG. 5 illustrates state tables 51A and 51B of a token management contract stored in the state DB. The token management contract is a smart contract that manages lumber tokens. The state table 51A is a state table of the block (#24768). The state table 51B is a state table of the block (#25007).

The state tables 51A and 51B include a token ID, state data, a consumed flag, and tracking data for each token. In the present embodiment, the token ID is used as the key of the state, but the key of the state is not limited to the token ID. Also, the tokens may be non-fungible tokens or alternatively fungible tokens.

The state data is data indicating a state, and in the example illustrated in the diagram, the state data includes an owner address and a lot number. The owner address is set with the address of the owner of the token at the time of the corresponding block. The lot number is set with a unit of manufacturing or ordering with respect to a target (in this case, lumber) indicated by the token.

The consumed flag is a flag indicating whether the token has been consumed. In the case where a token is merged or split, the original token is consumed, and the consumed flag is set to True (consumed). Alternatively, in the case where a token has not been merged or split, the token is not consumed, and the consumed flag is False (unconsumed).

The tracking data is data (data for tracking) that is used to track the history of a token. The tracking data of the present embodiment includes the update block number, the token ID, and the contract address. The update block number is set with the block number where state data has been updated. Here, in the case where at least one of pieces of state data is updated, the block number of the block where the update occurs is set in the update block number.

In the state table 51 of the block #24768, the state data associated with the token ID 1005 includes the owner “0x13ae . . . ”, the lot number “5”, and the consumed flag “False” (unconsumed), while the tracking data includes the update block number “23027”, the token ID: 1005, and the contract address “0xA6214 . . . ”.

Assume that the state data associated with the token ID: 1005 is not updated by the transactions included in the blocks #24769 to #25006. In this case, the approval terminal 2 continues to set the state data, the consumed flag, and the tracking data of the state table from the preceding block in association with the token ID: 1005 in each state table of the blocks #24769 to #25006 not illustrated. In other words, the data associated with the token ID: 1005 in each state table of the blocks #24769 to #25006 is the same as the data associated with the token ID: 1005 in the state table 51A of the block #24768.

Thereafter, the state data (owner address and lot number) associated with the token ID: 1005 is updated by a transaction included in the block #25007. In this case, the approval terminal 2 updates the state data associated with the token ID: 1005, while also updating the tracking data. Specifically, the approval terminal 2 sets the block number (#25007) of the current block in the update block number. Also, the approval terminal 2 sets the ID (1005) of the updated token and the contract address (0xA6214 . . . ) of the updated token in the tracking data.

In this way, in the present embodiment, the state (state data) for a key (token ID) is set together with tracking data. With this arrangement, in the present embodiment, if the user terminal 1 references the state table of the latest block #25009, tracking data indicating the most recent block in which an update occurred can be acquired. For example, in the case of the token ID: 1005, #25007 can be acquired as the update block number.

Additionally, the user terminal 1 specifies a search block number computed from the update block number, and acquires the state data and the update block number in the tracking data specified by the search block number. For example, the search block number is taken to be the block number obtained by subtracting 1 from the update block number. In the case of the token ID: 1005, 1 is subtracted from the update block number #25007 to specify the search block number #25006, and the state data and the update block number (#23027) in the tracking data in which the search block number is set are acquired. In this way, in the present embodiment, by tracing only blocks near the block in which the value of the state has changed, the search cost can be reduced greatly, and a history of changes to the value of the state can be acquired easily.

### 2. Token Merging

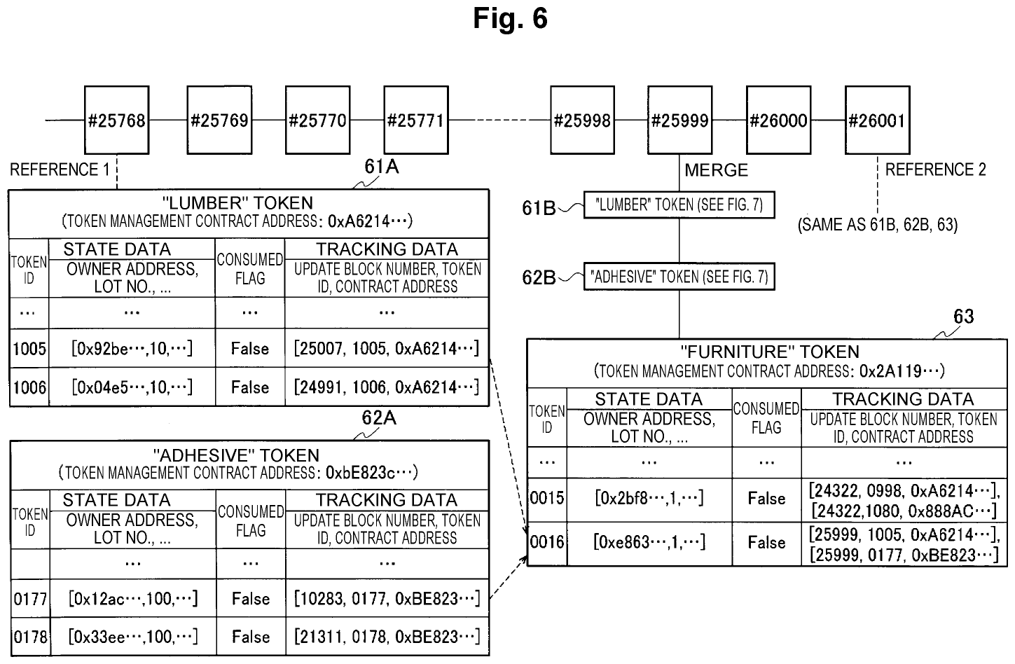

FIG. 6 is a schematic diagram for explaining a process of attaching tracking data to a token (or state) in the case of merging a plurality of tokens. In the example illustrated in the diagram, a lumber token and an adhesive token are merged to generate a furniture token as part of a process of manufacturing furniture from lumber. Here, the points that differ from “1. State updating” above will be described mainly.

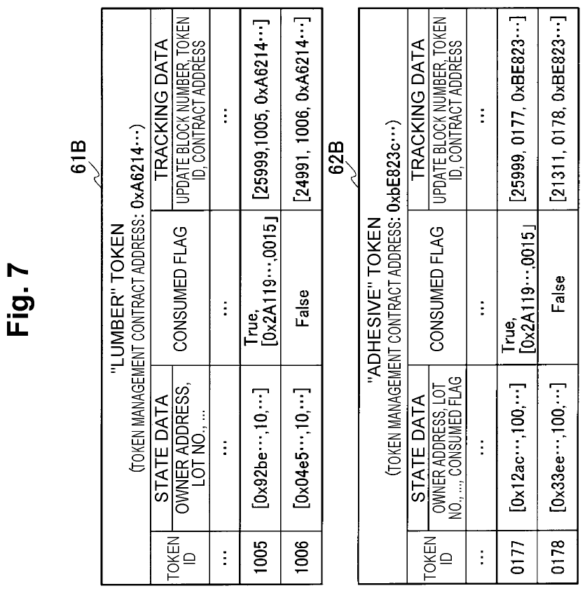

The state DB manages the states of tokens for each smart contract. FIGS. 6 and 7 illustrate state tables 61A and 61B of a lumber token management contract, state tables 62A and 62B of an adhesive token management contract, and a state table 63 of a furniture token management contract.

The state tables 61A and 61B are state tables of the block #25768. The state tables 61B, 62B, and 63 are state tables of the block #25999. As described above, the state tables include a token ID, state data, a consumed flag, and tracking data for each token.

For example, in the lumber state table 61A, the state data associated with the token ID: 1005 includes the owner “0x92be . . . ”, the lot number “10”, and the consumed flag “False” (unconsumed), while the tracking data includes the update block number “25007”, the token ID “1005”, and the contract address “0xA6214 . . . ”.

In the adhesive state table 62A, the state data associated with the token ID: 0177 includes the owner “0x12ac . . . ”, the lot number “100”, and the consumed flag “False” (unconsumed), while the tracking data includes the update block number “10283”, the token ID “0177”, and the contract address “0xBE823 . . . ”.

It is assumed that the state data associated with the token ID: 1005 in the state table 61A and the state data associated with the token ID: 0177 in the state table 62B are not updated by the transactions included in the blocks #25769 to #25998. In this case, the approval terminal 2 continues to set the data associated with the token ID: 1005 in the state table of the preceding block in association with the token ID: 1005 in each state table of the blocks #25769 to #25998 (not illustrated). In other words, the data associated with the token ID: 1005 in each state table of the blocks #25769 to #25998 is the same as the data associated with the token ID: 1005 in the state table 61A of the block #25768.

Similarly, in the adhesive state tables, the data associated with the token ID: 0177 in each state table of the blocks #25769 to #25998 is the same as the data associated with the token ID: 0177 in the state table 61B of the block #25768.

Additionally, the token (ID: 1005) in the state table 61A and the token (ID: 0177) in the state table 62A are merged and a furniture token is generated by a transaction included in the block #25999.

In this case, the approval terminal 2 generates data of the new furniture token merging the lumber token and the adhesive token, and sets the generated data in the adhesive state table 63 of the block #25999. Specifically, the approval terminal 2 sets a predetermined ID: 0016 in the token ID of the furniture token, sets the value specified by the transaction in the state data, sets “False” (unconsumed) in the consumed flag, and sets the two pieces of information for the merged lumber token (ID: 1005) and adhesive token (ID: 0177) in the tracking data.

Here, as the tracking data of the lumber token, the approval terminal 2 sets the update block number (#25999) of the block in which the furniture token is generated, the token ID (1005) of the lumber token, and the contract address (0xA6214 . . . ) of the lumber token. As the tracking data of the adhesive token, the approval terminal 2 sets the update block number (#25999) of the block in which the furniture token is generated, the token ID (0177) of the adhesive token, and the contract address (0xBE823 . . . ) of the adhesive token.

Also, the approval terminal 2 updates the state tables 61B and 62B of the merging parent tokens in the block #25999. As illustrated in FIG. 7, the approval terminal 2 updates the consumed flag of the merging parent lumber token (ID: 1005) in the state table 61B from “False” (unconsumed) to “True” (consumed). Similarly, the approval terminal 2 updates the consumed flag of the merging parent adhesive token (ID: 0177) in the state table 62B from “False” to “True”. The merging of the tokens causes the merging parent tokens to be consumed, and the consumed flag of each is updated to “True”. The merged token (furniture token) belongs to a different smart contract than the merging parent tokens, and has a different token ID.

Additionally, in the case of updating the consumed flag to “True”, the approval terminal 2 sets token information about the consumption destination (merging destination) in the consumed flag. In the present embodiment, the token information includes the contract address and the token ID.

Additionally, in the case of updating the consumed flag to “True”, the approval terminal 2 may also update the update block number of the tracking data to the consumed (merged) block number. In FIG. 7, block number (#25999) where the consumed flag is updated is set in the update block number of the tracking data of the merging parent lumber token (ID: 1005) in the state table 61B and the merging parent adhesive token (ID: 0177) in the state table 62B. With this arrangement, a user can easily know the block in which the consumed flag was updated to “True”.

Note that a token whose consumed flag has been updated to “True” is not updated, merged, or split in subsequent blocks, and therefore information on the token is not update at or after the block.

### 3. Token Splitting

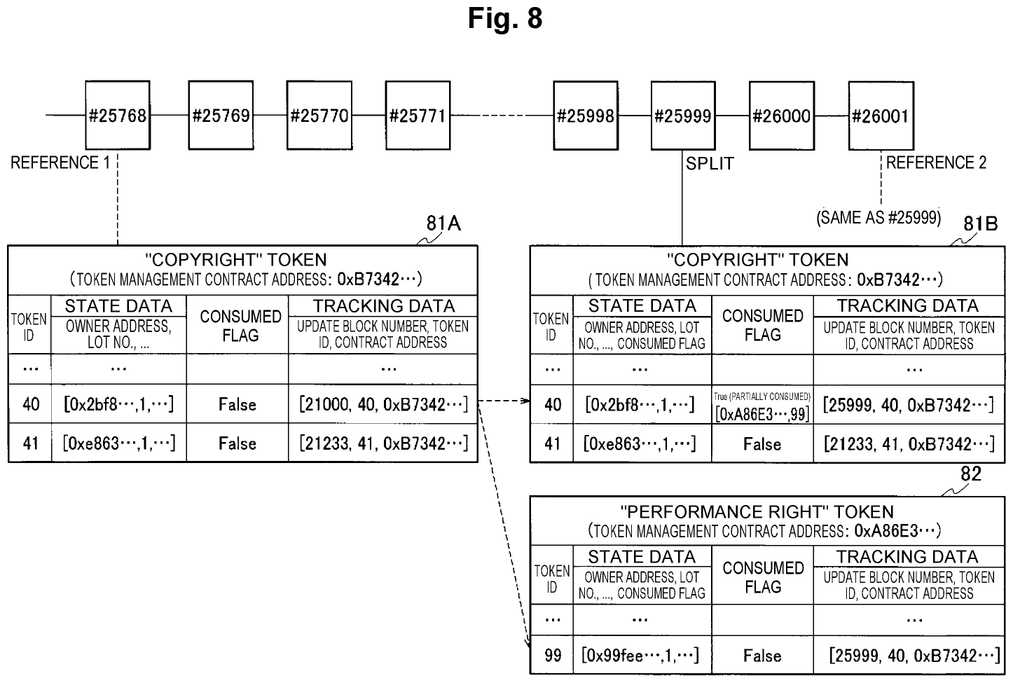

FIG. 8 is a schematic diagram for explaining a process of attaching tracking data to the value of a state when splitting a token. In the example illustrated in the diagram, a copyright is split by cutting a partial performance right away from the copyright of a piece of content. Here, the points that differ from “1. State updating” and “2. Token merging” above will be described mainly.

In the example illustrated in the diagram, the state DBs corresponding to each of the blocks are state tables 81A and 81B of a token management contract that manages a “copyright” token, and a state table 82 of a token management contract that manages a “performance right” token.

The state table 81A is a state table of the block #25768. The state tables 81B and 82 are state tables of the block #25999. As described above, the state tables include a token ID, state data, a consumed flag, and tracking data for each token.

It is assumed that the state data associated with the token ID: 40 in the state table 81A is not updated by the transactions included in the blocks #25769 to #25998. In this case, the approval terminal 2 continues to set the data associated with the token ID: 40 in the state table of the preceding block in association with the token ID: 40 in each state table of the blocks #25769 to #25998 (not illustrated). In other words, the data associated with the token ID: 40 in each state table of the blocks #25769 to #25998 is the same as the data associated with the token ID: 40 in the state table 81A of the block #25768.

Additionally, a performance right, which is a part of copyright, is cut away and split off from the copyright token (ID: 40) as a performance right token by a transaction included in the block #25999. In this case, the approval terminal 2 generates a new performance right token through splitting, and sets the performance right token in the performance right state table 82 of the block #25999.

Specifically, the approval terminal 2 sets a predetermined ID: 99 in the token ID of the performance right token, sets the value specified by the transaction in the state data, sets “False” (unconsumed) in the consumed flag, and sets information about the splitting parent copyright token (ID: 40) in the tracking data. Here, the approval terminal 2 sets the update block number (#25999) of the block in which the performance right token is generated, the token ID (40) of the copyright token, and the contract address (0xB7342 . . . ) of the copyright token as the tracking data.

The approval terminal 2 also updates the consumed flag of the splitting parent copyright token (ID: 40) in the state table 81B to “True (partially consumed)”. Additionally, in the case of updating the consumed flag to “True (partially consumed)”, the approval terminal 2 sets token information about the consumption destination (splitting destination) in the consumed flag to associate the information with the consumption destination. In the present embodiment, the token information includes the contract address and the token ID.

### Block Generation and Token History Search

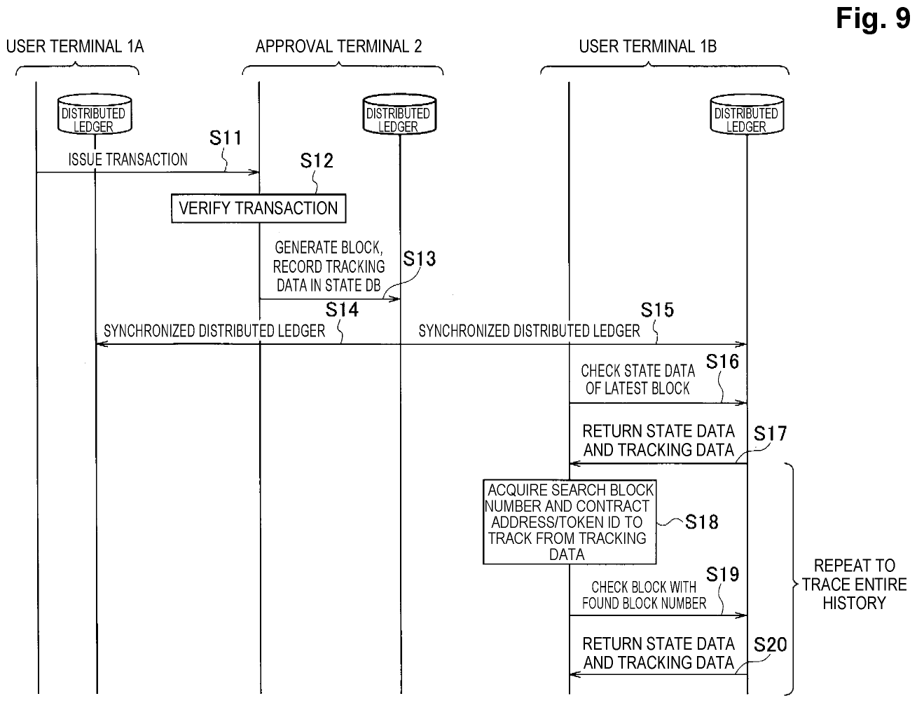

FIG. 9 is a sequence diagram illustrating block generation and history search according to the present embodiment.

In the process illustrated in the diagram, a user A issues a transaction that updates tokens (including merging and splitting), and a user B searches a history of tokens updated by the user A.

A user terminal 1A of the user A generates and issues a transaction for transferring a predetermined token from the user A to the user B, for example (S11). Specifically, the user terminal 1A broadcasts the transaction on the network 4. With this arrangement, the transaction is propagated to all terminals connected to the network 4.

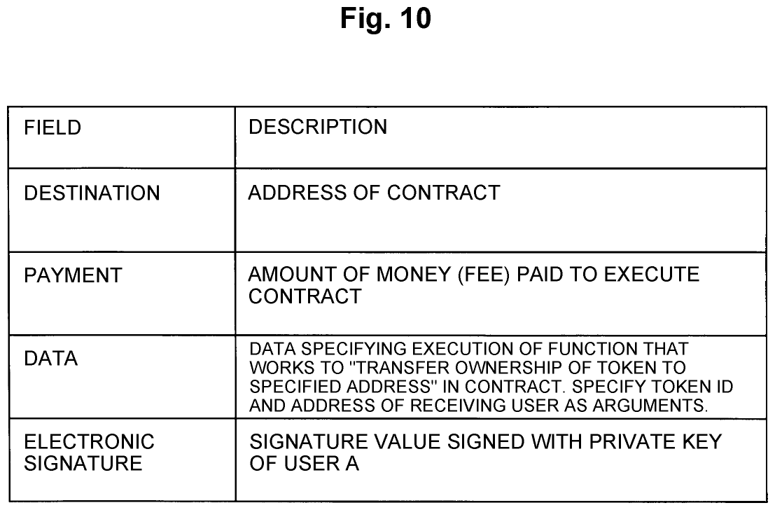

FIG. 10 is a table illustrating an example of the transaction in S11. The transaction illustrated in the table includes destination, payment, data, and electronic signature fields. In the destination field, the address of the smart contract (contract address) is set. In the payment field, an amount of money (a fee) paid to execute the smart contract is set.

The data field is set with data specifying the execution of a function that works to “transfer ownership of a predetermined token to the specified address” in the smart contract, for example. Note that parameters such as the ID of the token and the address of the receiving user are specified as arguments. In the electronic signature field, a signature value used to sign the transaction with the private key of the issuer of the transaction, namely the user A, is set.

Additionally, the approval terminal 2 (block issue unit 15) verifies (mines) the transaction transmitted in S11 (S12). Thereafter, the approval terminal 2 generates a single block by combining the transaction with other transactions occurred within a predetermined length of time. The block is added to the blockchain of the distributed ledger 11 of the approval terminal 2 itself through nonce mining (S13). Through the successful generation of a block by the approval terminal 2, the transaction transmitted in S11 is finalized (approved).

At this point, the approval terminal 2 updates each DB in the dataset of its own distributed ledger 11 on the basis of the transaction in S11, and sets the hash value of each updated DB in the block header of the block to be generated.

Also, when updating the state DB of the dataset, the approval terminal 2 updates the specified token according to the transaction in S11. In other words, the approval terminal 2 changes the state data of a token, merges tokens, or splits a token. Also, in the present embodiment, the approval terminal 2 stores, in the state DB, tracking data including the block number of the block in which the token is updated, the token ID, and the contract address.

Additionally, the approval terminal 2 sets the hash value of the updated state DB in the block header of the block to be generated. Note that S13 is a process performed by one of all terminals connected to the network which one successfully generate a block the earliest.

Additionally, through loose synchronization among the terminals, the block including the transaction transmitted in S11 is reflected in the distributed ledger 11 of all terminals connected to the network 4 (S14 and S15). In other words, the blockchain control unit 12 in every terminal adds the block including the transaction of S11 to its own stored distributed ledger 11. Also, the blockchain control unit 12 in every terminal updates the state DB of the dataset in its own distributed ledger 11 on the basis of the transaction included in the block, similarly to the approval terminal 2.

Next, in the case where the user B searches a past history of tokens updated by the user A, the processes at or after S16 are performed. Specifically, a user terminal 1B queries its own distributed ledger for the state data of the token in the latest block (S16), and acquires the state data and the tracking data in the latest block from the distributed ledger (S17).

For example, in the case where the latest block is #25009 illustrated in FIG. 5 and the token ID of the query target is 1005, the user terminal 1B references the state DB 51B in its own distributed ledger, and acquires the state data and the tracking data including the update block number #25007. With this arrangement, the user B is able to confirm the current state value of the token, and also recognize that the token was updated in the block #25007.

Additionally, if the user B intends to search the past history of the token, the user B repeats the processes from S18 to S20. In other words, the user terminal 1B acquires the search block number as well as the contract address and token ID of the desired token to search for from the tracking data in S17 (S18).

Specifically, the user terminal 1B computes the search block number on the basis of the acquired update block number. Here, the block number obtained by subtracting “1” from the update block number is treated as the search block number. Thereafter, the user terminal 1B specifies the search block number, the contract address, and the token ID, queries its own distributed ledger for data about the specified token in the search block number (S19), and acquires the state data and tracking data of the token specified in the specified block from the distributed ledger (S20).

For example, in the state DB of FIG. 5, in the case where the update block number #25007 and the token ID 1005 are acquired in S17, the user terminal 1B specifies the search block number #25006 obtained by subtracting “1” from #25007, and queries the distributed ledger. The state DB in #25006 is not illustrated in FIG. 5, but since no updates are performed with respect to the token ID: 1005, from #24769 to #25006, the state of #25006 regarding the token ID: 1005 is the same as the state DB 51A in #24768. Consequently, the user terminal 1B references the state DB in #25006, and acquires the state data and the tracking data including the update block number #23027.

Additionally, in the case of intending to search the history farther back into the past, the user terminal 1B repeats the processes from S18 to S20. With this arrangement, the user B is able to trace the past history of a token efficiently.

Also, the tracking data of the present embodiment includes not only the update block number, but also the token ID and the contract address. Consequently, in the present embodiment, a history of a token can be tracked efficiently, even if the token is merged or split, and the desired token to search for is changed to a different token ID of a different smart contract.

Next, a token search using the consumed flag in the tracking data will be described.

Here, a process will be described in which a user uses the consumed flag to search for the current state of a merged token (consumption destination token) that is the merging destination of a certain token.

For example, in the case of acquiring the consumed flag of the token (ID: 1005) in the lumber state table 61B illustrated in FIG. 7, the user terminal 1 specifies the merged token that is the merging destination of the token as well as the contract address (0x2A119 . . . ) and the token ID (0015) set in the consumed flag, queries its own distributed ledger for data about the specified token in the latest block, and acquires the state data and tracking data of the token in the latest block from the distributed ledger. With this arrangement, the user is able to acquire the current state of a desired token.

For example, in the case where the latest block is #26001 illustrated in FIG. 6, the user terminal 1B acquires the state data and tracking data from the furniture state table in the latest block (which is the same as the state table 63 in #25999) from its own distributed ledger. Consequently, the user is able to confirm the current state data (owner, lot number) of the merged token (ID: 0016) that is the merging destination of the lumber token (ID: 1005). Also, in the case where the user intends to search the past history of the merged token (ID: 0016), the user can acquire the past history by performing the processes from S16 to S20 illustrated in FIG. 9.

The process by which the user searches for the current state of a split token (consumption destination token) that is the splitting destination of a certain token by using the consumed flag is similar to the process for the merged token.

In the present embodiment described above, a blockchain system is provided with the user terminal 1 and the approval terminal 2. The distributed ledger 11 of the blockchain system includes a state DB that stores the state of a smart contract for each token. The user terminal 1 is provided with the transaction issue unit 13 that issues transactions that update tokens. The approval terminal 2 is provided with the update unit 154 that updates tokens in the state DB, and the block generation unit 153 that generates a block including the transaction and causes the block and the updated state DB to be reflected in the distributed ledger 11. The update unit 154 sets tracking data in the token in the state DB, the tracking data including an update block number of the block in which the token is updated, the ID of the token, and the contract address of the token.

In this way, in the present embodiment, tracking data including the update block number of the block in which an update occurs, the token ID, and the contract address at the time when the token is updated is attached to the updated token in the state DB of the distributed ledger 11 in each terminal. Consequently, by tracing the update block number, a user is able to track the history of a token easily in the distributed ledger (blockchain), without referencing all previous blocks and transactions. In other words, in the present embodiment, a past history and transitions of the state of a smart contract can be acquired easily and quickly without maintaining an external database or index DB.

Also, the tracking data according to the present embodiment includes the update block number of the block in which the token is updated, the ID of the token, and the address of the smart contract of the token. Consequently, in the present embodiment, the history of a token can be tracked easily for not only “updating” the state of the token, but also “merging” and “splitting” with other tokens. In other words, rather than simply tracing a history of a token having the same token ID in the same smart contract, the history can be tracked through associations with tokens having different token IDs and different smart contracts. Consequently, in the present embodiment, the history of a token can be tracked and a trace route can be expressed even if the token is updated in complex ways, such as being merged or split.

Also, in the present embodiment, the approval terminal 2 sets the consumed flag and information about the consumption destination token in the token. Consequently, in the present embodiment, the state of a token that is the consumption destination of a token consumed by merging or splitting can be acquired.

Also, in the present embodiment, traceability can be improved for users of smart contracts. In the state DB of the related art, information about which block in the past includes an update or change to the value of a state is not kept. Accordingly, it is not easy for a user to know which block includes a transition of a state value. In the related art, in order to know the block number of a block in which a change has occurred, it is necessary to search all blocks or transactions, which imposes a large burden on the user. In contrast, in the present embodiment, tracking data including the block number at the time when a block is generated (mined) is attached to the value of the desired state to track as the changing point of the value of the state in the state DB. This can improve the traceability of the state.

Note that for the user terminal 1 and the approval terminal 2 described above, a general-purpose computer system provided with a central processing unit (CPU) or processor, memory, storage (hard disk drive (HDD), solid-state drive (SSD)), a communication device, an input device, and an output device may be used. In the computer system, individual functions of each device are performed by causing the CPU to execute a predetermined program loaded on the memory. For example, individual functions of the user terminal 1 and the approval terminal 2 are performed by causing the CPU of the user terminal 1 to execute a program for the user terminal 1, and causing the CPU of the approval terminal 2 to execute a program for the approval terminal 2 respectively.

Additionally, the program for the user terminal 1 and the program for the approval terminal 2 may be stored in a computer-readable recording medium such as an HDD, an SSD, USB memory, CD-ROM, DVD-ROM, or MO disc, or alternatively may also be delivered over a network.

Furthermore, the present invention is not limited to the above embodiment, and various modifications are possible within the scope of the gist of the present invention.

For example, in the present embodiment, the approval terminal 2 sets the block number of the block in which a state value is updated as the update block number in the state DB. However, instead of the update block number, a block number for searching may be set in the state DB. In other words, instead of the update block number, the approval terminal 2 may set the search block number obtained by subtracting “1” from the update block number in the state DB. In this case, when the user terminal 1 acquires the past history of the state (S18 in FIG. 9), the user terminal 1 does not need to compute the search block number from the update block number, but instead can use the search block number acquired from the distributed ledger directly to trace the past history.

Also, although the state DB (state table) of the present embodiment is provided with the consumed flag, the state DB (state table) does not need to include the consumed flag.

### REFERENCE SIGNS LIST

1 User terminal
2 Approval terminal
11 Distributed ledger
12 Blockchain control unit
13 Transaction issue unit
14 History search unit
15 Block issue unit
151 Consensus execution unit
152 Transaction verification unit
153 Block generation unit
154 Update unit
4 Blockchain network

1. A blockchain system comprising:
a user terminal; and
an approval terminal, wherein a distributed ledger of the blockchain system includes a state database that stores a state of a smart contract for each token;
the user terminal includes:
a transaction issue unit that issues a transaction that updates a token,
the approval terminal includes:
an update unit that updates the token in the state database, and
a block generation unit that generates a block including the transaction, and causes the block and the updated state database to be reflected in the distributed ledger, and
the update unit sets tracking data in the token in the state database, the tracking data including an update block number of the block in which the token is updated, and token information on the token.

2. The blockchain system according to claim 1, wherein
the transaction issue unit issues a transaction that merges a plurality of the tokens, and
the update unit sets, in a merged token obtained by merging the plurality of tokens, as the tracking data, a block number of a block generating the merged token, as well as token IDs and smart contract addresses of the plurality of merging parent tokens.

3. The blockchain system according to claim 2, wherein
the update unit sets a flag indicating that the token is consumed in each of the plurality of merging parent tokens in the state database.

4. The blockchain system according to claim 1, wherein
the transaction issue unit issues a transaction that splits the token, and
the update unit sets, in a split token obtained by splitting the token, as the tracking data, a block number of a block generating the split token as well as a token ID and a smart contract address of the splitting parent token.

5. An approval terminal that approves a transaction in a blockchain system, the approval terminal comprising:
a distributed ledger that includes a state database that stores a state of a smart contract for each token;
a reception unit that receives a transaction that updates a token;
an update unit that updates the token in the state database; and
a block generation unit that generates a block including the transaction, and causes the block and the updated state database to be reflected in the distributed ledger, wherein
the update unit sets tracking data in the token in the state database, the tracking data including an update block number of a block in which the token is updated, and token information on the token.

6. (canceled)

7. A history management method that manages a history of a blockchain, wherein
a distributed ledger of the blockchain includes a state database that stores a state of a smart contract for each token,
the history management method comprising:
issuing, by a user terminal, a transaction that updates a token;
updating, by an approval terminal, the token in the state database; and
generating, by the approval terminal, a block including the transaction, and causing the block and the updated state database to be reflected in the distributed ledger, wherein
in the step of updating, tracking data is set in the token in the state database, the tracking data including an update block number of a block in which the token is updated, and token information on the token.

8. (canceled)
